(19) United States
(12) Patent Application Publication
(10) Pub. No.: US 2009/0273859 A1
(43) Pub. Date: Nov. 5, 2009

(54) FORMING A POLE TIP TOPOGRAPHY

(76) Inventors: Eric W. Flint, San Jose, CA (US); Cherngye Hwang, San Jose, CA (US); Kenneth M.T. Liu, San Jose, CA (US); Eduardo Torres Mireles, Tlaquepaque (MX); Yongjian Sun, San Jose, CA (US)

Correspondence Address: HITACHI C/O WAGNER BLECHER LLP, 123 WESTRIDGE DRIVE, WATSONVILLE, CA, 95076, US

(21) Appl. No.: 12/114,502

(22) Filed: May 2, 2008

(51) Int. Cl. G11B 5/60

(52) U.S. Cl. 360/235.4

(57) ABSTRACT

A method of forming a pole tip topography associated with an air bearing surface (ABS) of a hard disk drive slider is disclosed. The method etches an exposed pole tip region of an ABS at a first angle with respect to the ABS to remove an irregularity from the exposed pole tip region and to flatten the exposed pole tip region. The exposed pole tip region lacks a photo-resist layer. The method also includes etching the flattened exposed pole tip region of the ABS at a second angle with respect to the ABS to form a recession with reference to the ABS.

### FIELD

The field of the present technology relates to hard disk drive manufacturing. More particularly, embodiments of the present technology relate to manufacturing the air bearing surface associated with a hard disk drive slider.

### BACKGROUND

Hard disk drives are used in many electronic devices such as desktop computers, laptop computers, MP3 players, Global Positioning Systems, Personal Digital Assistant devices and other devices for data storage. As a key component of hard disk drive, a magnetic head reads and writes the data from and onto a magnetic disk while the magnetic head flies above the disk at a well defined distance. This distance is also called the fly height in the data storage industry. The fly height is a function of many factors, including the patterned shape of the air bearing surface, various levels of cavities on the air bearing surface, the depth of the cavities, and the rail width. Ion beam etching is one of the processes in conjunction with the photo lithography process used to create a cavity with a designed depth and shape on an air bearing surface. However, the magnetic spacing between disk and sensor of magnetic head also includes disk overcoat thickness, head overcoat thickness, and recession of sensor to the air bearing surface (ABS). The recession of sensor with respect to the ABS is created form the slider fab lapping and the ion beam etching before the carbon overcoat deposition.

However, ion beam etching has been used widely in wafer fabrication. Some are used for directional cleaning of surface; some are used to form a pattern through trimming during a variety of wafer process steps. There exist many limitations to the current state of technology with respect to ion beam etching. For example, these different processing steps of different design considerations create functionality complications in regards to the hard disk drive.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method of forming a pole-tip topography associated with an air bearing surface (ABS) of a hard disk drive slider is disclosed. The method etches an exposed pole tip region of an ABS at a first angle with respect to the ABS to remove an irregularity from the exposed pole tip region and to flatten the exposed pole tip region. The exposed pole tip region lacks a photo-resist layer. The method also includes etching the flattened exposed pole tip region of the ABS at a second angle with respect to the ABS to form a recession with reference to the ABS. The term “flatten” mainly refers to the reduction of topographical difference between metallic layers (sensor/shields) and ABS.

### BRIEF DESCRIPTION OF THE DRAWINGS

FIG. 1 is a diagram of an example multiple angle ion beam etching apparatus which mills at multiple angles, in accordance with one embodiment of the present technology.

FIG. 2 is a block diagram of an example control module coupled with an example multiple angle ion beam etching apparatus in accordance with one embodiment of the present technology.

FIG. 3 is drawing of an incoming head topography with a sensor, metal smear, and metal oxide in accordance with one embodiment of the present technology.

FIG. 4A is a drawing of ion beam etching of an exposed pole tip region of an air bearing surface at a first angle in accordance with one embodiment of the present technology.

FIG. 4B is a drawing of ion beam etching of an exposed pole tip region of an air bearing surface at a second angle in accordance with one embodiment of the present technology.

FIG. 5 is a flowchart of an example method of forming a pole tip topography in accordance with one embodiment of the present technology.

The drawings referred to in this description should be understood as not being drawn to scale except if specifically noted.

### DETAILED DESCRIPTION

Reference will now be made in detail to embodiments of the present technology. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, it will be recognized by one of ordinary skill in the art that the present technology may be practiced without these specific details. In other instances, well known methods, procedures, components, and have not been described in detail as not to unnecessarily obscure aspects of the present embodiments.

Embodiments of the present technology etch with an ion beam a hard disk drive slider at multiple angles in order to remove surface irregularities from an exposed pole tip region of an ABS, to flatten the exposed pole tip region, and then to recess the exposed pole tip region of the ABS at a pre-determined ABS pole tip profile. By ion beam etching at multiple angles, embodiments of the present technology reduce the chances of wide distribution of pole tip recession, and thus narrow the distribution of the magnetic spacing.

The discussion will begin with an overview of an ion beam etching process according to embodiments of the present technology, and the role an etched ABS pole tip topography plays in the performance of magnetic heads. The discussion will then focus on embodiments and methods of the present technology that provide a multiple angle ion beam etching apparatus for forming a pole tip topography associated with an ABS of a hard disk drive slider, including removal of ABS irregularities.

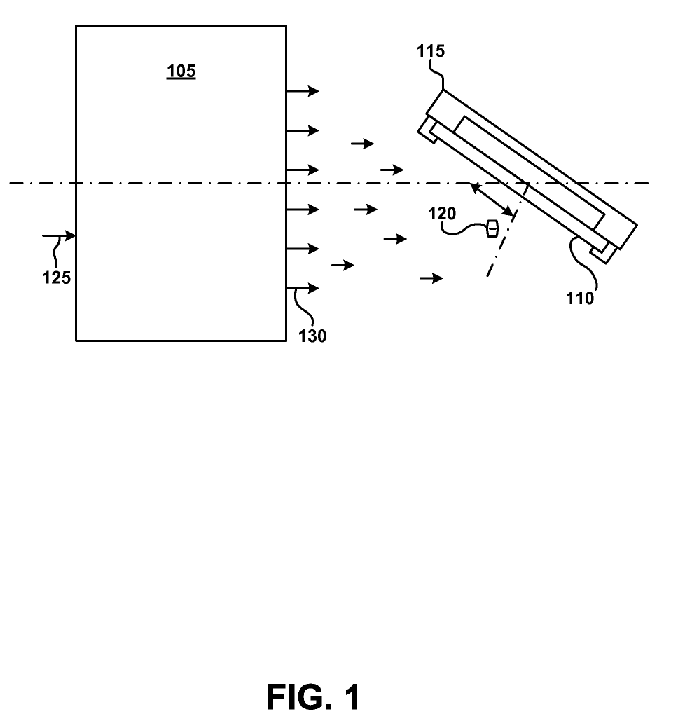

With reference now to FIG. 1, a diagram of one embodiment of the present technology, a multiple angle ion beam etching apparatus, is shown. Multiple angle ion beam etching apparatus comprises ion emitter 105 configured for generating ion beam 130, and fixture 115 for positioning the ABS at a plurality of angles 120 with respect to the ABS. Fixture 115 is configured to couple with hard disk drive slider (slider) 110. Ion emitter 105 may be any ion emitter capable of emitting received material 125 as ions 130. In one embodiment, material 125 is argon gas, and ions 130 are argon ions. It is appreciated that material 125 and ions 130 may be a material other than Argon.

Slider 110 as represented in FIG. 1 may be just one slider or a plurality of sliders exposed to the etching process of ion emitter 105. Additionally, a plurality of sliders may be termed to be a ‘pallet’.

Embodiments of the present technology project ions 130 towards fixture 115 at multiple angles 120 such that ions 130 projected at a first angle clean an exposed pole tip region of an ABS of all irregularities as well as flatten the exposed pole tip region, and ions 130 projected at a second angle recess the flattened exposed pole tip region in order to provide a desired ABS profile. The term “flatten” mainly refers to the reduction of topographical difference between metallic layers (sensor/shields/poles) and ABS.

It is important to note that the exposed pole tip region of the ABS lacks a layer of photo-resist. Whereas the remaining pole tip region of the ABS may or may not contain a photo-resist layer. Additionally, the exposed pole tip region of the ABS includes one or more of the following: sensor, shield 1, shield 2, pole 1, pole 2, undercoat, and overcoat. The pole tip topography is defined as the profile differences of shield 1, shield 2, pole 1, pole 2, sensor, undercoat and overcoat in reference to the exposed ABS.

For example, during the first etch at a first pre-determined angle theta 120, ions 130 are projected towards slider 110 at a pre-determined speed for a pre-determined time period, to encounter slider 110. In this manner, an exposed pole tip region of the ABS is cleaned of all irregularities as well as flattened. Additionally, fixture 115 and slider 110 continuously rotate during the ion beam etching process, while maintaining the first pre-determined fixed angle theta 120. The axis of rotation for fixture 115 and slider 110 is perpendicular to the plane of slider 110. Furthermore, in one embodiment, fixture 115 and slider 110 remain still while being etched and maintain a first pre-determined fixed angle theta 120 for the duration of the first etch. Rotating fixture 115 enables the evenly distributed etching of the exposed pole tip region of the ABS.

During the second etch, ions 130 are then projected towards slider 110 at a pre-determined speed for a pre-determined time period, to encounter slider 110 at a second pre-determined angle theta 120. In this manner, the flattened exposed pole tip region of the ABS is etched to achieve a desired recession, and thus a desired pole tip topography. Additionally, fixture 115 and slider 110 continuously rotate during the ion beam etching process, while maintaining the second pre-determined fixed angle theta 120. Furthermore, in one embodiment, fixture 115 and slider 110 remain still while being etched and maintain a second pre-determined fixed angle theta 120.

The multiple angle ion beam etching apparatus etches slider 110 such that a desired ABS pole-tip topography is achieved. This ABS pole-tip topography plays an increasingly important role in the performance of magnetic heads. For example, a clean exposed pole tip region of an ABS (without surface irregularities) allows for good overcoat (such as Si/Carbon or AiN/Carbon) adhesion to the shields, the sensor, and the metallic poles. Furthermore, a less recessed sensor, and thus a reduced magnetic spacing, is desirable in order to get a better magnetic signal. On the other hand, more recessed poles and Al₂O₃ overcoat is desired to reduce the opportunity of head-disk contact and potential head-disk damage (e.g., wear and scratch) during thermally expanded operation (e.g., read or write).

Embodiments of the present technology provide for multiple angle etchings which remove irregularities and flatten an exposed pole tip region of an ABS at a first pre-determined angle in preparation for etching the flattened ABS at a second pre-determined angle, during which time a desired recession of an exposed pole tip region of an ABS is achieved. Etching at multiple angles reduces the chance or both overetching and underetching. For example, the present technology provides for one or more etchings at a very glancing angle with respect to an ABS of slider 110 which will provide for removing an irregularity without creating unnecessary shield and sensor recessions. Next, embodiments of the present technology provides for one or more etchings at a more vertical angle with respect to an ABS of slider 110 which will produce a predetermined shield recession in reference to the ABS. This multiple angle etching is conducted consecutively and in the same process run. Consequently, this multiple angle etching enables the multiple angle ion beam etching apparatus to manage irregularity removal of an exposed area of an ABS while also creating a more exact and desired sensor and shield topography, with improved control of overetching and underetching.

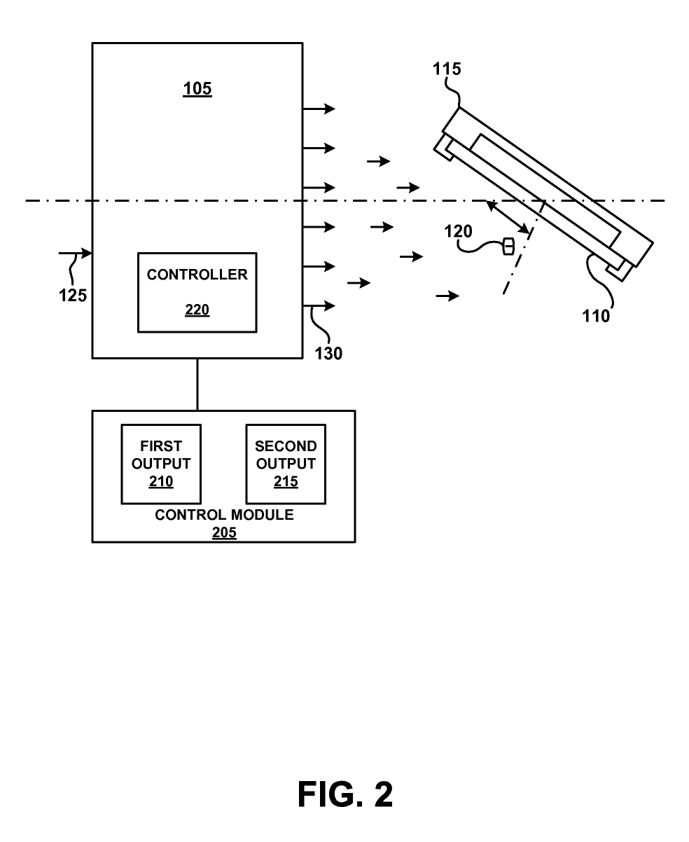

With reference now to FIG. 2, a block diagram of an example control module 205 coupled with a multiple angle ion beam etching apparatus in accordance with one embodiment of the present technology is shown. In one embodiment, controller 220 of the multiple angle ion beam etching apparatus is coupled with control module 205. Control module 205 is coupled with first output 210 and second output 215. In one embodiment, control module 205 is configured for forming a pole tip topography associated with an exposed pole tip region of an ABS of hard disk drive slider (slider) 110.

In one embodiment, first output 210 is configured for initiating the etching of an exposed pole tip region of an ABS at a first angle to remove an irregularity from the exposed pole tip region and to flatten the exposed pole tip region. In one embodiment, the first angle is less than 90 degrees. Of note, at a first angle which is less than or equal to 30 degrees with respect to the ABS, the NiFe etch rate is less than or equal to the etch rate of the N58 substrate (Al₂O₃—TiC substrate). The etching time associated with etching at the first angle is defined from a smear removal index (e.g., sensor resistance distribution dependency on time). Oxide removal can be verified through XPS or Auger analyses. Given the nature of incoming sliders after lapping, the level of smear and the thickness of oxides, as well as other surface contaminates, normally varies. Abundant etching at the first angle will ensure the cleanliness as well as flatness of the exposed pole tip region of an ABS.

Second output 215 is configured for initiating the ion milling of the flattened exposed portion of an ABS at a second angle to form a recession with reference to the ABS. The second angle is more vertical than the first angle, with respect to the ABS. Of note, at the etching angle of greater than or equal to 40 degrees with respect to the ABS, the NiFe etch rate is much higher than the etch rate of the N58 substrate. The higher the etch rate, the more recessed the pole tip topography becomes. Most of the pole tip materials shown in ABS surface are NiFe and CoFe based. Their etch rates show the similar trend against N58 substrate.

In one embodiment, the coupling between controller 220 and control module 205 includes a feedback loop. The feedback loop is configured for providing information associated with the etching at the first angle and at the second angle. It is appreciated that first input 210 and second input 215 may be a single output.

Additionally, in one example, ion beam 130 etches the flattened exposed pole tip region of the ABS at the second angle after ion beam 130 etches the ABS at the first angle, without any intervening etches. In yet another example, embodiments of the present technology provide for a multiple angle ion beam etching apparatus which etches the flattened exposed pole tip region of the ABS at the second angle in the same process run as ion beam 130 etches the exposed pole tip region of the ABS at the first angle.

In one embodiment, the irregularity removed from the exposed pole tip region of the ABS may include smears, oxides, contaminants, or any other surface irregularities. Contaminants may be surface contaminants such as an organic monolayer or any other contaminates. Smears may occur from ABS lapping, or any other ABS processing. Smear removal is very critical for Tunneling Magnetoresistance (TMR) devices because the smears normally short the device with much lower than expected resistance. Oxides may be those such as FeOx, CoOx, etc. The material used to etch at the first angle and the second angle may be any material capable of etching the exposed portion of the ABS.

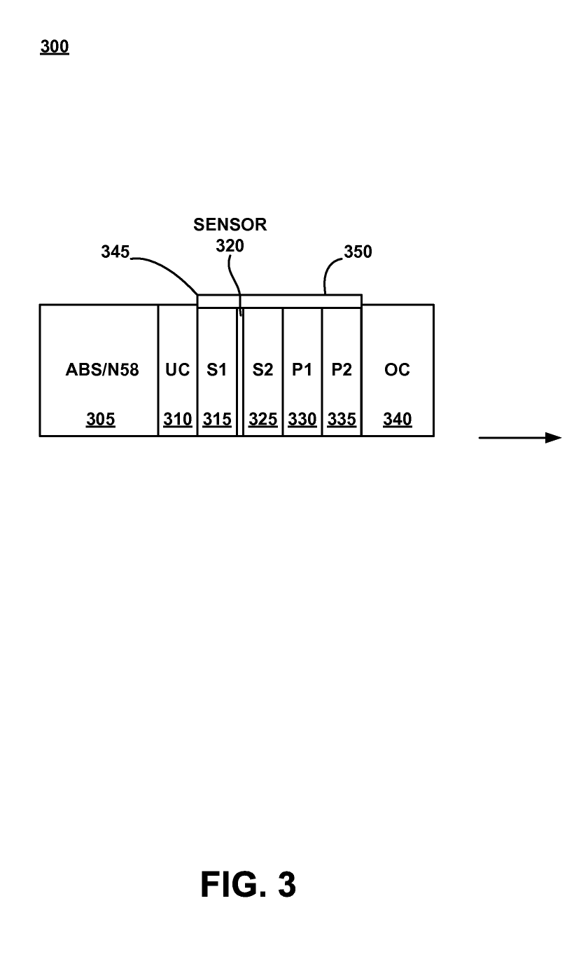

Referring to FIG. 3, a pre-etched pole tip topography associated with an exposed pole tip region of ABS 305 of slider 110 includes shield 1 (S1) 315, sensor 320, shield 2 (S2) 325, pole 1 (P1) 330, pole 2 (P2) 335, undercoat (UC) 310, and overcoat (OC) 340. However, UC 310 and OC 340 may be more recessed than the rest of the pole-tip topography. Additionally, metal oxide 345 is positioned underneath metal smear 350. Furthermore, the metal smears may not necessarily be continuous. Generally, sensor 320, and S1315, S2 325, P1 330, and P2 335 are made of NiFe and CoFe alloys. UC 310 and OC 340 are generally made of Al₂O₃. Embodiments of the present technology enable the removal of smear 350 and oxide 345 (and other surface irregularities) in order to clean an exposed pole tip region of ABS 305 as well as to flatten the exposed pole tip region of ABS 305. Smear removal is particularly critical to the TMR device because the smears on the top of the MgO barrier layer short the device and thus increase the device resistance fallout and yield loss. Oxide removal enhances the adhesion of slider overcoat (Si/C or SiN/C) to all the metallic layers at the ABS and thus ensures the protection of the device from corrosion and wear damages. Significantly, the pre-etched pole tip topography associated with the exposed portion of ABS 305 is lacking a photo-resist layer. Whereas, the remaining portion of ABS 305 may or may not contain a photo-resist layer.

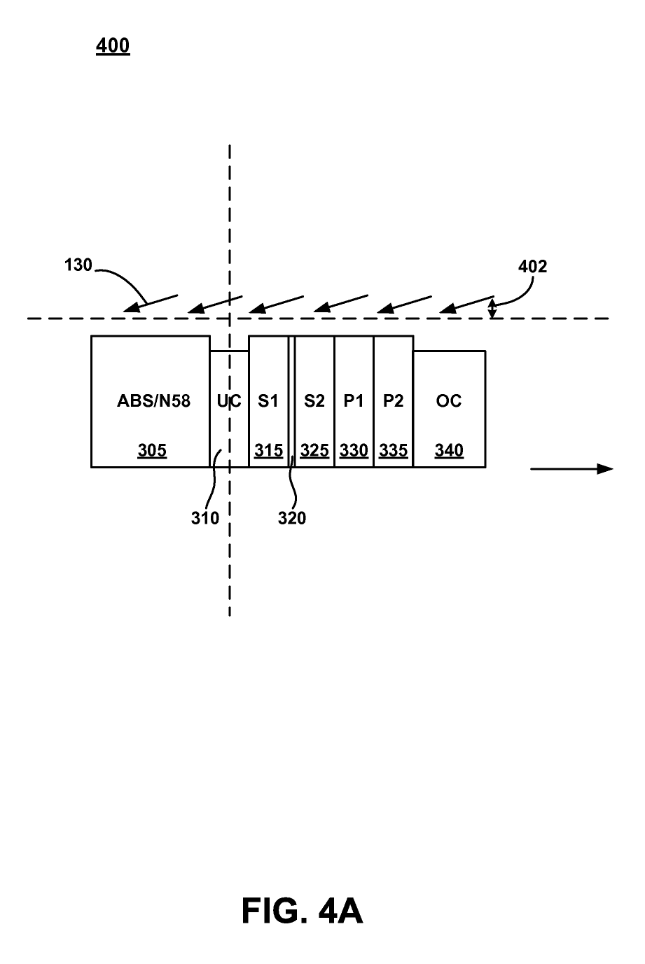

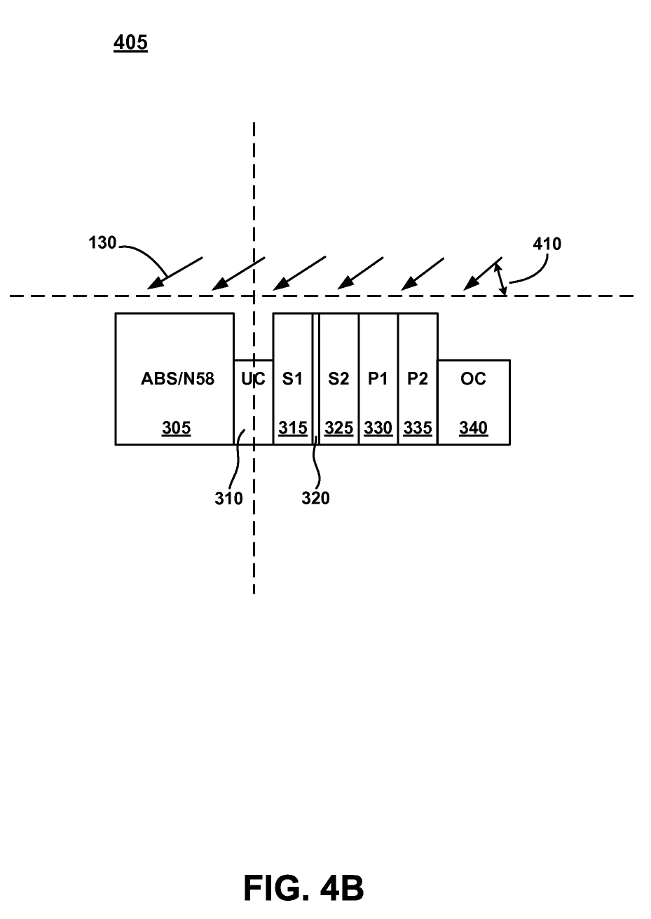

Referring to FIG. 4A, a drawing of an ion beam milling of an exposed pole tip region of ABS 305 at a first angle 402 in accordance with one embodiment of the present technology is shown. Note that smear 350 and oxide 345 have been removed. A flattened exposed pole tip region of ABS 305 refers to S1 315, sensor 320, S2 325, P1 330 and P2 335 all being relatively even with each other compared to the prior ABS 305 profile. The UC 310 and the OC 340, in a flattened exposed pole tip region of ABS 305 may be at the same level as the rest of the pole tip topography, or may be more recessed than the rest of the pole tip topography. Angle 402 is with respect to ABS 305. Angle 402 is less than or equal to 30 degrees.

Referring to FIG. 4B, a drawing of ion beam etching of ABS 305 at second angle 410 in accordance with one embodiment of the present technology is shown. This drawing depicts etching at second angle 410 after etching at first angle 402 is performed. Ion beams 130 etching at second angle 410 form a recession with respect to ABS 305. The recession formed refers to a predetermined ABS 305 profile of S1 315, sensor 320, S2 325, P1 330, P2 335, UC 310 and/or OC 340. Angle 410 is with respect to ABS 305. Angle 410 is greater than or equal to 40 degrees.

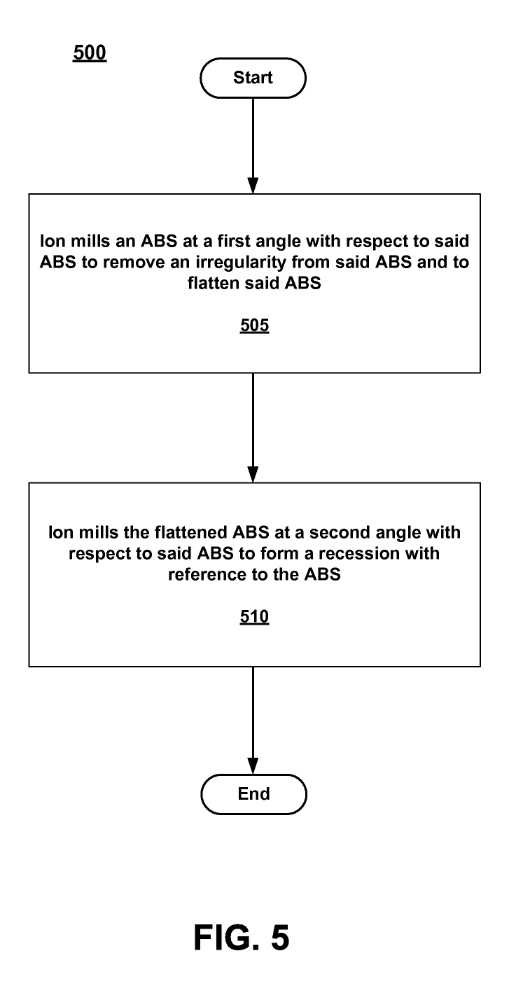

With reference now to FIG. 5, a flowchart of an example method 500 of forming a pole-tip topography associated with an exposed pole tip region of ABS of a slider, is shown in accordance with one embodiment of the present technology. As described herein, at 505, one embodiment of the present technology etches an exposed pole tip region of an ABS at a first angle with respect to the ABS to remove an irregularity from the exposed pole tip region and to flatten the exposed pole tip region. In one embodiment, the first angle is less than or equal to 30 degrees with respect to the ABS. Additionally, in one example of the present technology, the irregularity is a smear. In another example, the irregularity is an oxide.

In another embodiment, at 510, the present technology etches the flattened exposed pole tip region of the ABS at a second angle with respect to the ABS to form a recession with reference to the ABS. In one embodiment of the present technology, the second angle is more vertical than the first angle with respect to the ABS. In one embodiment, the second angle is more than or equal to 40 degrees with respect to the ABS. In one example of the present technology, the ion beam etching of the flattened exposed pole tip region of the ABS at a second angle is performed after the ion beam etching of the exposed pole tip region of the ABS at a first angle. For instance, ion beam etching of the exposed pole tip region of the ABS at the second angle after the ion beam etching of the exposed pole tip region of the ABS at the first angle occurs without any intervening etchings. In another example, the ion beam etching of the exposed pole tip region of the ABS at a second angle is done in the same process run as the ion beam etching of the exposed pole tip region of the ABS at a first angle.

Thus, the present technology provides a system and method for forming a pole tip topography associated with ABS 305 of hard disk drive slider 110. An exposed pole tip region of the etched ABS 305 is etched at first angle 402 with respect to ABS 305 to remove an irregularity from the exposed pole tip region and to flatten the exposed pole tip region. The flattened exposed pole tip region of ABS 305 is then etched at second angle 410 with respect to ABS 305 to form a recession with reference to ABS 305.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of forming a pole tip topography associated with an air bearing surface (ABS) of a hard disk drive slider, said method comprising:
etching an exposed pole tip region of an ABS at a first angle with respect to said ABS to remove an irregularity from said exposed pole tip region and to flatten said exposed pole tip region, said exposed pole tip region lacking a photo-resist layer; and
etching said flattened exposed pole tip region of said ABS at a second angle with respect to said ABS to form a recession with reference to said ABS.

2. The method as described in claim 1 wherein said first angle is less than or equal to 30 degrees with respect to said ABS.

3. The method as described in claim 2 wherein said second angle is more vertical than said first angle with respect to said ABS, and said second angle is greater than or equal to 40 degrees with respect to said ABS.

4. The method as described in claim 1 wherein said etching said flattened exposed pole tip region of said ABS at a second angle is performed after said etching an exposed pole tip region of an ABS at a first angle.

5. The method as described in claim 1 wherein said etching said flattened exposed pole tip region of said ABS at a second angle is done in the same process run as said etching an exposed pole tip region of an ABS at a first angle.

6. The method as described in claim 1 wherein said irregularity is a smear.

7. The method as described in claim 1 wherein said irregularity is an oxide.

8. A multiple angle ion beam etching apparatus for providing an air bearing surface (ABS) profile, said apparatus comprising:
an ion beam etcher for etching said ABS; and
a fixture for positioning said ABS at a plurality of angles with respect to said ABS wherein said ion beam etches an exposed area of said ABS at a first angle to remove a first pole tip region of said exposed area and to flatten said exposed area, said exposed area lacking a photo-resist layer, and wherein said ion beam etches said flattened exposed area of said ABS at a second angle to remove a second pole tip region of said exposed area to form a recession with reference to said ABS.

9. The apparatus as described in claim 8 wherein said first portion is an irregularity.

10. The apparatus as described in claim 9 wherein said irregularity is a smear.

11. The apparatus as described in claim 9 wherein said irregularity is an oxide.

12. The apparatus as described in claim 8 wherein said first angle is less than or equal to 30 degrees with respect to said ABS.

13. The apparatus as described in claim 8 wherein said second angle is more vertical than said first angle with respect to said ABS, and said second angle is greater than or equal to 40 degrees with respect to said ABS.

14. The apparatus as described in claim 8 wherein said apparatus is configured for initiating an ion beam etching of said flattened exposed area of said ABS at a second angle after said ion beam etches an exposed area of an ABS at a first angle.

15. The apparatus as described in claim 8 wherein said apparatus is configured for etching said flattened exposed area of an ABS at a second angle in the same process run as said ion beam etches an exposed area of an ABS at a first angle.

16. A control module for forming a pole tip topography, said control module comprising:
a first output coupled with a controller, said first output configured for initiating ion beam etching an exposed pole tip region of an ABS at a first angle to remove an irregularity and to flatten said exposed pole tip region, wherein said exposed pole tip region lacks a photo-resist layer; and
a second output coupled with a controller, said second output configured for initiating ion beam etching said flattened exposed pole tip region of said ABS at a second angle to form a recession with reference to said ABS.

17. The control module as described in claim 16 wherein said first angle is less than or equal to 30 degrees with respect to said ABS, and said second angle is greater than or equal to 40 degrees with respect to said ABS.

18. The control module as described in claim 16 wherein said control module has a feedback loop coupled with an ion beam etcher, said feedback loop configured for providing information associated with said ion beam etching at said first angle and said second angle.

19. The control module as described in claim 16 wherein a first output is also coupled to a rotatable fixture for positioning said ABS at said first angle.

20. The control module as described in claim 16 wherein said irregularity is selected from a group of irregularities consisting of: contaminants, smears, and oxides.
